(19) United States
(12) Patent Application Publication
(10) Pub. No.: US 2010/0031188 A1
(43) Pub. Date: Feb. 4, 2010

(54) METHOD FOR ZOOMING IMAGE AND ELECTRONIC DEVICE USING THE SAME

(75) Inventor: Po-Hsien Liu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/406,085

(22) Filed: Mar. 17, 2009

(30) Foreign Application Priority Data
Aug. 1, 2008 (CN) 200810303319.6

(51) Int. Cl. G06F 3/048

(52) U.S. Cl. 715/801

(57) ABSTRACT

A method for zooming images may include the following steps: a closed line is traced on a touch panel and a tracing direction of the closed line is determined. An area enclosed by the closed line is then determined. A zooming ratio is computed according to the area. The image is zoomed according to the tracing direction and the zooming ratio. An electronic device using the method is also described.

### BACKGROUND

1. Technical Field

The present disclosure relates to image zooming, and particularly to methods for zooming an image and electronic devices using the methods.

2. Description of Related Art

Touch panel displays are widely used in electronic devices to act as input and output devices. However, zooming an image in or out can be difficult with some displays and devices.

Therefore, there is room for improvement within the art.

### BRIEF DESCRIPTION OF THE DRAWINGS

FIG. 1 is a flowchart of a method for zooming an image in accordance with an exemplary embodiment.

FIG. 2 is a pictorial representation of clockwise tracing a closed line on a touch panel in accordance with an exemplary embodiment.

FIG. 3 is a pictorial representation of counter-clockwise tracing a closed line on a touch panel in accordance with an exemplary embodiment.

FIG. 4 is a flowchart of details of a step S311 of FIG. 1, in accordance with an exemplary embodiment.

FIG. 5 is a block diagram of an electronic device in accordance with an exemplary embodiment.

### DETAILED DESCRIPTION OF EXEMPLARY EMBODIMENTS

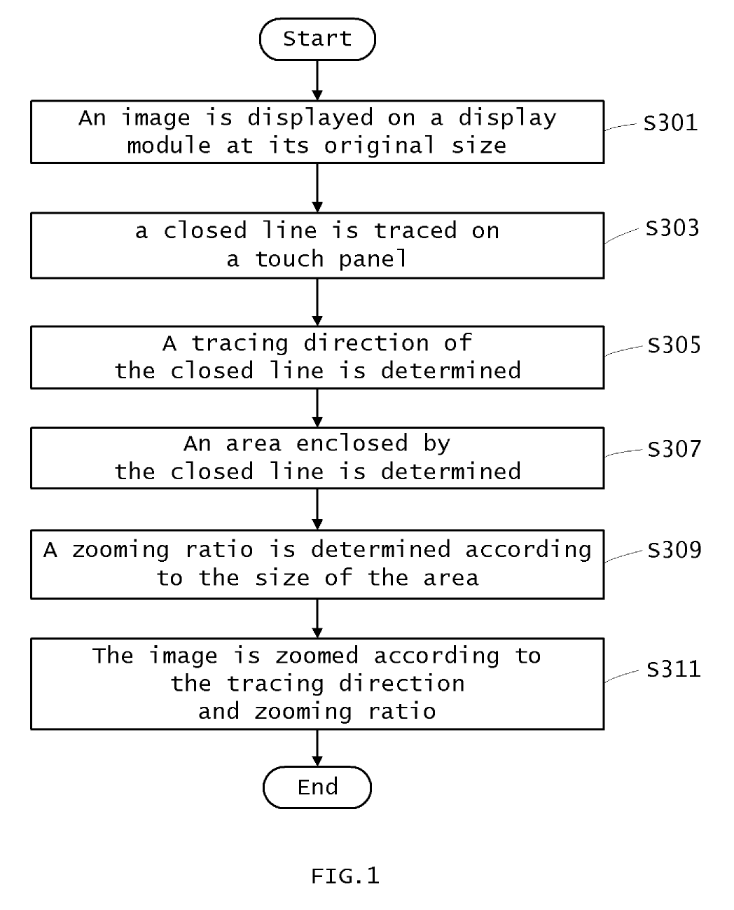

Referring to FIG. 1, a flowchart of a method for zooming an image in accordance with an exemplary embodiment is shown. The various actions in the method may be performed in the order presented, or may be performed in a different order. Furthermore, in some embodiments, some actions shown in FIG. 1 may be omitted from the method. The method may include the following steps.

In step S301, the image is displayed on a display module of an electronic device at its original size.

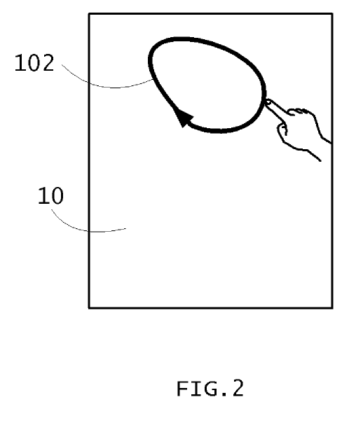

In step S303, a closed line is traced on a touch panel using a finger or a tool (e.g., pen or stylus). The closed line is composed of all the traced touch points. The coordinates of a first of the touch points is the point where the finger or tool first contacts the touch panel. The line is considered closed when coordinates of a current touch point are substantially identical to the coordinates of the first touch point. For example, referring to FIG. 2, a closed line 102 composed of touch points is traced on a touch panel 10.

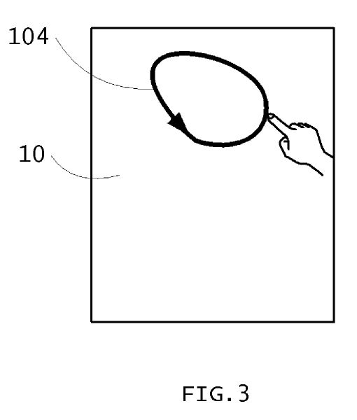

In step S305, a tracing direction of the closed line is determined. The tracing direction may be clockwise or counter-clockwise, corresponding to, e.g., zooming in or zooming out (see step S313 etc). The tracing direction of the closed line 102 in FIG. 2 is clockwise. The tracing direction of the closed line 104 in FIG. 3 is counter-clockwise.

In step S307, an area enclosed by the closed line is determined. The area may be computed using the coordinates of the touch points forming the closed line. In other embodiments, a perimeter or other characteristic data of the closed line can be used instead of the area.

In step S309, a zooming ratio is determined according to the size of the area enclosed by the closed line. It may be understood that a relationship between the zooming ratio and the size of the enclosed area is predetermined and stored in the device's memory. For example, the zoom ratio can be directly proportional to the change in size of the enclosed area.

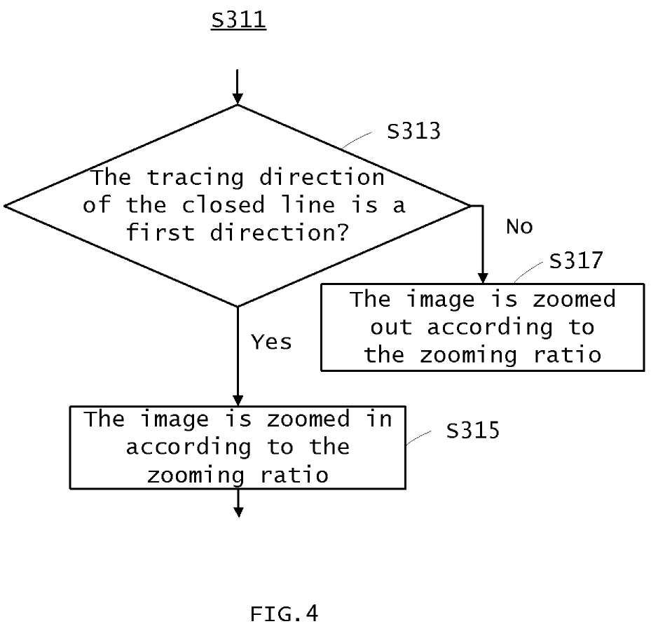

In step S311, the image displayed on the display module is zoomed according to the tracing direction and the zooming ratio. Therefore, as shown in FIG. 4, in step S313, the tracing direction of the closed line is determined to be a first direction. When the tracing direction of the closed line is the first direction such as a clockwise direction, step S315 is implemented. When the tracing direction of the closed line is not the first direction such as a counter-clockwise direction, step S317 is implemented.

In step S315, the image is zoomed in according to the zooming ratio.

In step S317, the image is zoomed out according to the zooming ratio.

Using the above method, the image can be easily zoomed using one finger or tool.

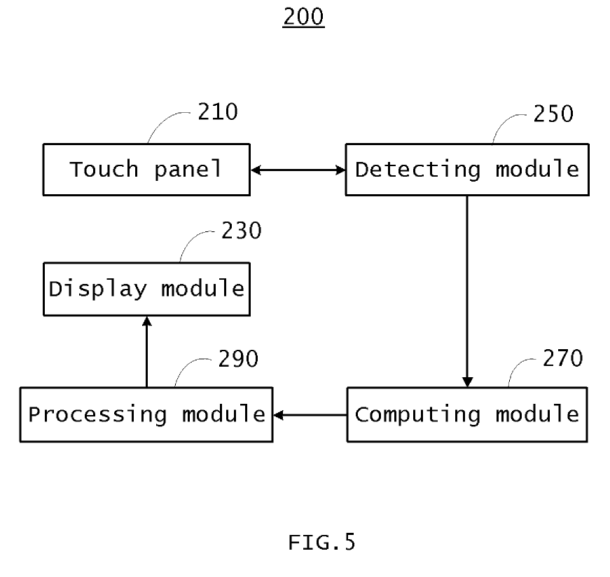

Referring to FIG. 5, an electronic device 200 includes a touch panel 210, a display module 230, a detecting module 250, a computing module 270, and a processing module 290. The touch panel 210 may be integrated with the display module 230. The electronic device 200 may be a handset, a digital camera, or other devices having a touch panel 210.

The touch panel 210 receives the touch points traced using a finger or a tool.

The display module 230 displays an image.

The detecting module 250 determines the coordinates of traced touch points and determines formation of a closed line according to the coordinates of the touch points, as described according to the above method.

The computing module 270 computes a tracing direction of the closed line, an area enclosed by the closed line, and a zooming ratio based on the size of the area enclosed by the closed line, as described according to the above method.

The processing module 290 zooms the image according to the tracing direction and the zooming ratio, and outputs the zoomed image to the display module 230, as described according to the above method.

Using the above electronic device 200 with a touch panel 210, the image can be easily zoomed by using one finger or tool.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A method for zooming an image comprising:
tracing a closed line over an image displayed on a touch panel;
determining a tracing direction of the closed line; and
zooming the image according to the tracing direction.

2. The method according to claim 1, wherein the step of zooming the image according to the tracing direction comprises:
zooming in the image if the tracing direction of the closed line is determined to be a first direction.

3. The method according to claim 2, further comprising:
zooming out the image if the tracing direction of the closed line is determined not to be the first direction.

4. The method according to claim 1, further comprising:
determining a zooming ratio according to a characteristic of the closed line; and
zooming the image according to the zooming ratio.

5. The method according to claim 4, wherein the step of determining a zooming ratio according to the characteristic of the closed line comprises:
determining the area enclosed by the closed line; and
determining a zooming ratio according to the size of the determined area.

6. The method according to claim 4, wherein the step of determining a zooming ratio according to the characteristic of the closed line comprises:
determining the perimeter of the closed line; and
determining a zooming ratio according to the determined perimeter.

7. The method according to claim 1, wherein the closed line is composed of touch points, and the closed line is determined when coordinates of a current tracing point are substantially identical to an original touch point.

8. A method for zooming an image comprising:
tracing a closed line over an image displayed on a touch panel;
determining a zooming ratio according to a characteristic of the closed line; and
zooming the image according to the zooming ratio.

9. The method according to claim 8, wherein the step of determining a zooming ratio according to the characteristic of the closed line comprises:
determining the area enclosed by the closed line; and
determining a zooming ratio according to the size of the determined area.

10. The method according to claim 8, wherein the step of determining a zooming ratio according to the characteristic of the closed line comprises:
determining the perimeter of the closed line; and
determining a zooming ratio according to the determined perimeter.

11. The method according to claim 8, further comprising:
determining a tracing direction of the closed line; and
zooming the image according to the tracing direction.

12. The method according to claim 11, wherein the step of zooming the image according to the tracing direction comprises:
zooming in the image if the tracing direction of the closed line is determined to be a first direction.

13. The method according to claim 12, further comprising:
zooming out the image if the tracing direction of the closed line is determined not to be the first direction.

14. An electronic device comprising:
a touch panel for receiving touch points;
a display module for displaying an image;
a detecting module for determining the formation of a closed line traced on the touch panel;
a computing module for computing a tracing direction of the closed line; and
a processing module for zooming the image according to the tracing direction and outputting the zoomed image to the display module.

15. The electronic device according to claim 14, wherein the processing module zooms in the image when the tracing direction of the closed line is a first direction.

16. The electronic device according to claim 15, wherein the processing module zooms out the image when the tracing direction of the closed line is not the first direction.

17. The electronic device according to claim 14, wherein the computing module computes a zooming ratio according to a characteristic of the closed line; the processing module also zooms the image according to the zooming ratio and outputs the zoomed image to the display module.

18. The electronic device according to claim 17, wherein the computing module computes the size of an area enclosed by the closed line, and the zooming ratio is based upon the size of the area.

19. The electronic device according to claim 17, wherein the computing module computes a perimeter of the closed line, and the zooming ratio is based on the perimeter.

20. The electronic device according to claim 14, wherein the closed line is composed of touch points; the detecting module detects coordinates of touch points when traced on the touch panel and determines the formation of a closed line when coordinates of a current tracing point are substantially identical to the coordinates of an original point traced on the touch panel.
